(19) United States
(12) Patent Application Publication
(10) Pub. No.: US 2003/0215304 A1
(43) Pub. Date: Nov. 20, 2003

(54) Groove based anchoring fasteners

(76) Inventor: Sergio Natero, Miami, FL (US)

Correspondence Address: Sergio Natero, 21 SW 55 AV, #C, Miami, FL, 33134, US

(21) Appl. No.: 10/366,891

(22) Filed: Feb. 14, 2003

Related U.S. Application Data
(60) Provisional application No. 60/366,993, filed on Mar. 25, 2002.

(51) Int. Cl. F16B 39/00

(52) U.S. Cl. 411/107

(57) ABSTRACT

Fastening system device using a groove made on any hard surface with a diamond or similar cutting wheel anchoring with traction forces.

A clip having an “L” shape fits one side in the groove without adhesive. The other exposed side of the clip with a rectangular opening for the application and positioning of an square neck bolt, nut or wingnut and a bridge holding profile.

A “T” togle inside the rectangular opening may replace, depending of working space and thickness of elements to be held, bolt, nut or similar and bridge profile. Using “L” clip's elasticity to anchor.

### TECHNICAL FIELD

The present invention relates to fastening devices used in holding undermounth Stainless Steel and Ceramic sinks in bars, kitchen counters and vanity tops made in marbles, granites and stones in general.

They can be applied, between others, to diswasher machines fixing the holding tabs provided from the manufacturer in order to prevent it from basculating forward when the door is opened.

### BACKGROUND ART

Traditional anchoring systems have the need of a cylindrical hole, as point of application for traction forces, made with a boring tool or machine.

Holding an undermounth sink requires as many holes as clips involved to fix it. If ¾ inch thickness in stone is used, as usually happens, the deep at which these holes can be made will be only ½ inch.

Impact drilling, if faster, can brake or crack seriously the stone and for this reason becomes impossible.

During the drilling operation, high stress on material and tools is developed, so, water becomes the choice element for cooling and lubrication.

Fasteners with conical inserts (FIG. 1) find no use in ¾ thickeness material, because there is not enough depth for its expansive action.

Another system uses a brass insert (FIG. 2).

After drilling, drying off the water remaining after boring becomes necessary for the application of an adhesive to affix the insert. Once set, a clip with a rectangular hole of rounded extremes is fixed with the aid of a 10-24 match screw.

All of this can take any where from 30 to 60 minutes in its entirety (for just 4 clips). Large sinks may need 6 to 8 of these clips.

### DETAILED DESCRIPTION

The extended use of circular diamond cutting wheels of little diameter (4-4 ½ in.) used in electric hand grinders, have been a common tool of choice in stone and construction industries it's cappable to make a clean, free of vibration non throw groove of approximate ⅛ in. width and ½ in. depth. Been very simple to control profundity of this groove preventing to go beyond the thickness of material ruining the finished surface of the work piece at the other side. These tools, in general, rotates at speeds of 10.000 R.P.M and this operation will last 8 sec. or less, depending on the strength of the material itself.

A clip (FIG. 3) strong and flexible in construction like steel, stainless or treated in proper way to avoid corrosion if humidity environments are present, having an “L” shape, thickness less than the groove in order to fit in it one of the wings, with a rounded extreme as of a portion segment of blade perimeter. (FIG. 4).

A square slot giving a tab to compensate adjusting differences between groove and clip thickness whit a simple spade screw driver, once pushed, this tab will give the first holding force maintaining in place the clip and other elements (FIG. 5). The other wing having a pucker {(a) FIG. 5} pointing toward the square angle limits the depth at which the clip is thrusted in, inside the groove leaving an ¼ in. space between material and clip for the head of carriage bolt type to fit in and move freely along a rectangular opening {(d) FIG. 3} away or toward the groove adding more positioning alternatives to the last holding clip. This latest one (FIG. 6) made with the same material will be the bridge for holding forces to actuate between groove and sink, flat in shape, except for one extremity and having a rectangular opening similar to the previous clip but with rounded sides giving a “telescopic” and even a little sideways positioning alternative (FIG. 7—top view). One extremity with a pucker to properly adjust sink shape and sides, and a nut (or windnut to avoid overtighting) closing the requirements for the present system to work.(FIG. 8)

Traction force actuating throw the clips is changing in two compression forces acting at different levels and opposing to each other.

{(a)(b)(c) FIG. 8}

This uses no adhessive and for this reason can be taken away; if there is interference during installation of tops, simply apply light turning force with a spade screwdriver under the exposed wing of the “L” clip and near the groove. (FIG. 5)

This kind of fastener needs, for its actuation, between sink border and groove a distance of 1 in. to 1½ in.

A variation to the previous system with less parts compromised, faster application and less needed distance between groove and sink limit uses the same “L” shaped clip. Instead of a carriage bolt there is a “T” togle with an “S” shape (FIG. 9).

The upper part of this tab having a teethlike, rough surface {(a) FIG. 9}, presses the sink lip against the material, closing the gap and preventing slip and pushpull motion during installation or removal.

The other part {(b) FIG. 9},slippery one, glide or sweeps pushing against the inner side of the clip.

This tab uses the spring action of the “L” shaped clip, moving along the rectangular hole (FIG. 10).

Once the clip is located inside the groove with the toggle pointing away from it (the groove) and pushing the lever extreme until it stops against the same clip and material will lock the system based in its own elasticity.

Pulling down this tab will free the clip again with no need of screwdriver as in the previous version.

### BRIEF DESCRIPTION OF THE SEVERAL VIEWS OF THE DRAWINGS

FIG. 1: Four traditional anchoring fasteners lateral view using expansive system.

FIG. 2: Side view showing mounting clip with brass insert and a top view of allocation of this clips holding an oval ceramic sink (traditional method).

FIG. 3: Side perspective of GBA Fastener's base to be allocated inside the groove

FIG. 4: Back view of GBA Fastener's comparing its profile with a 4.5 in. standard diamond cutting wheel.

FIG. 5: Side view of GBA Fastener's base with carriage type bolt (square neck) and spade type screw driver pushing the holding tab.

FIG. 6: Top perspective view of bridge clip.

FIG. 7: Top view of side ways positioning alternatives of bridge clip.

FIG. 8: Side cutting view of material showing the GBA Fastener in place and action forces (arrows).

FIG. 9: Top perspective view of “T” togle with an “S” shape.

FIG. 10: Top perspective view of complete GBA Fastener using the “T” togle.

FIG. 11: Side cutting view of material showing GBA Fastener at work and how pushing or pulling on the “T” togle (arrows show direction) may clamp or free its actuation.

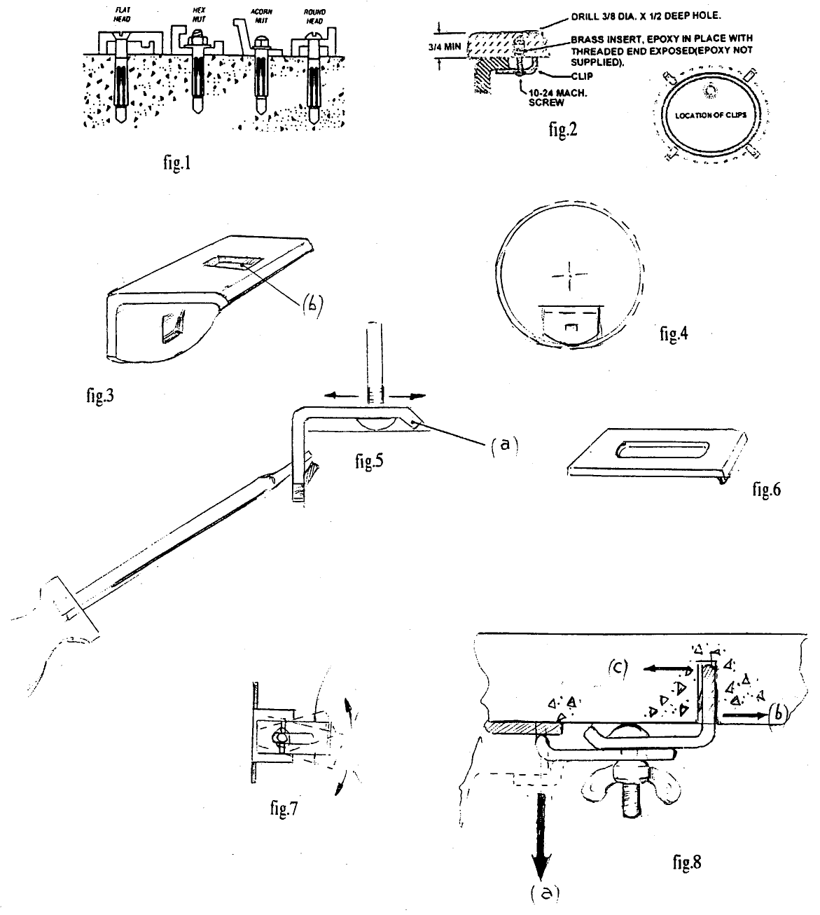

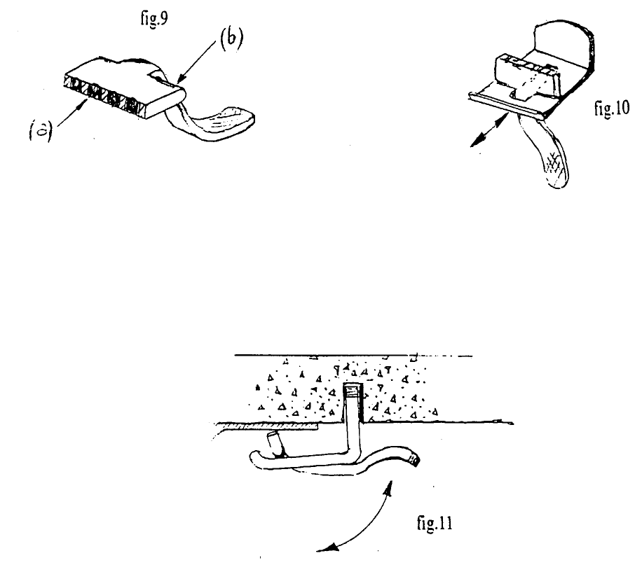

I claim:

1. A linear groove to hold and fit in this device.

2. An “L” shaped clip having:
a) A rectangular hollow for a carriage bolt to move in.
b) A pucker to limit depth inside the groove.
c) A tab to adjust clip inside the groove.

3. Carriage bolt and wing nut.

4. A flat clip having:
a) A rectangular hollow with rounded extremes.
b) An end, following piece profile to be held.

5. A “T” or similar togle replacing bolt, wingnut and bridge clip with:
a) Teethlike, rough upper part preventing sweep.
b) Rounded lower part for mobility.
c) “S” like profile to lock clip spring action.
